(19) United States
(12) Patent Application Publication
(10) Pub. No.: US 2002/0175890 A1
(43) Pub. Date: Nov. 28, 2002

(54) Liquid crystal driver device and liquid crystal driver unit

(75) Inventors: Shiro Dosho, Osaka (JP); Keijiro Umehara, Kyoto (JP); Yuusuke Tokunaga, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd

(21) Appl. No.: 10/150,928

(22) Filed: May 21, 2002

(30) Foreign Application Priority Data
May 23, 2001 (JP) 2001-153830

(51) Int. Cl. G09G 3/36

(52) U.S. Cl. 345/100

(57) ABSTRACT

A digital signal corresponding to each pixel of a liquid crystal display (LCD) is converted into an analog signal by a digital-to-analog (D-A) converting section. A CCD (Charge Coupled Device) delay line sequentially transfers the received analog signal according to a transfer clock signal. In response to a drive control signal, a signal output section receives the analog signal from the CCD delay line for output as a pixel signal of the LCD. The above structure eliminates the need to provide a multiplicity of D-A converters corresponding to the number of pixels per scanning line.

### BACKGROUND OF THE INVENTION

The present invention relates to a liquid crystal driver device for driving a liquid crystal display (LCD).

Conventionally, a liquid crystal driver device for driving a LCD together with a gate driver is known in the art. More specifically, the gate driver sequentially selects a scanning line of the LCD, and the liquid crystal driver device synchronously applies an analog luminance value to each pixel on the selected scanning line. For example, the gate driver sequentially selects a scanning line of the LCD in the vertical direction (from top to bottom), and the liquid crystal driver device sequentially applies a luminance value to each pixel on the selected scanning line of the LCD in the horizontal direction (from left to right). In this way, a luminous value is applied to all pixels, thereby driving the LCD.

FIG. 11 is a block diagram showing an example of the structure of a conventional liquid crystal driver device. The liquid crystal driver device in FIG. 11 includes a shift register 51 for sequentially receiving a digital signal DS corresponding to each pixel of a liquid crystal display (LCD) 107, digital-to-analog (D-A) converters 52 for converting an output signal of the shift register 51 into an analog signal, and output buffers 53 for receiving the analog signal from a corresponding D-A converter 52 for output to the LCD 107. The shift register 51 has D flip-flops 54 arranged in series with each other. The number of D flip-flops 54 in the shift register 51 corresponds to the number of pixels per scanning line. Similarly, the number of D-A converters 52 and the number of output buffers 53 each corresponds to the number of pixels per scanning line.

In the shift register 51, a digital signal DS stored in each D flip-flop 54 is transferred to an adjacent D flip-flop 54 in synchronization with a transfer clock signal ZTCK output from a drive circuit 55. As shown in FIG. 12, once the digital signal DS corresponding to a single scanning line is applied to the shift register 51, the drive circuit 55 then outputs a drive control signal ZSDC to each D-A converter 52. In response to the drive control signal ZSDC, each D-A converter 52 receives the digital signal DS stored in a corresponding D flip-flop 54 and converts the received digital signal DS into an analog signal. The analog signal is output to the LCD 107 through a respective output buffer 53. In this way, a luminance value is applied to each pixel.

In the conventional liquid crystal driver device, the shift register 51 transfers a digital signal DS corresponding to each pixel to each D-A converter 52, which in turn converts the digital signal DS into an analog signal. Accordingly, a D-A converter 52 must be provided for every output buffer 53, that is, for every pixel on a scanning line.

The conventional liquid crystal driver device normally uses about 6-bit or 7-bit D-A converters. In order to implement a high-performance LCD 107 with a large screen, however, a liquid crystal driver device with improved capability is required. Accordingly, about 10-bit D-A converters are required.

For example, however, the area occupied by a 10-bit D-A converter is about sixteen times that occupied by a 6-bit D-A converter. Since the conventional liquid crystal driver device has a D-A converter for every pixel on a scanning line, replacing a 6-bit D-A converter with a 10-bit D-A converter significantly increases the circuit scale, hindering implementation of a compact D-A converting section. This is extremely disadvantageous for mounting the D-A converting section and also causes increase in costs of the liquid crystal driver device.

### SUMMARY OF THE INVENTION

It is an object of the present invention to simplify the structure of a liquid crystal driver device. The present invention converts a digital signal corresponding to each pixel of a liquid crystal display (LCD) into an analog signal by a digital-to-analog (D-A) converter and then transfers the analog signal by a transfer means.

More specifically, according to one aspect of the present invention, a liquid crystal driver device for driving a LCD according to a digital signal corresponding to each pixel of the LCD includes a D-A converting section for converting the digital signal into an analog signal, a drive control section for outputting a transfer clock signal and a drive control signal, a signal transfer section having a transfer means including series-connected delay stages, for sequentially transferring the analog signal output from the D-A converting section across the transfer means according to the transfer clock signal, and a signal output section for receiving the analog signal from each delay stage of the transfer means and outputting the received analog signal as a pixel signal of the LCD in response to the drive control signal.

According to the present invention, a digital signal corresponding to each pixel of the LCD is first converted into an analog signal by the D-A converting section, and the analog signal is then transferred by the transfer means. This eliminates the need to provide a multiplicity of D-A converters corresponding to the number of pixels per scanning line. As a result, the structure of the liquid crystal driver device can be simplified, enabling implementation of a compact liquid crystal driver device. Moreover, costs of the components can be reduced. Since a D-A converter having a large bit width can be easily mounted in the liquid crystal driver device, the capability of the liquid crystal driver device can be improved.

The transfer means is preferably formed by a CCD (Charge Coupled Device) delay line. The D-A converting section is preferably provided on a symmetry axis of a layout of the liquid crystal driver device.

Preferably, the D-A converting section includes a plurality of D-A converters, and the D-A converters convert digital signals corresponding to different pixels into analog signals in parallel. In this structure, the D-A converting section includes a plurality of D-A converters operating in parallel. This enables the use of a D-A converter having a lower clock frequency. Accordingly, EMI (electromagnetic interference) noise as well as costs of the components can be reduced.

Preferably, the signal transfer section includes a plurality of transfer means. The plurality of transfer means respectively correspond to a plurality of segments of a scanning line of the LCD, and the number of delay stages included in each transfer means is at least the same as the number of pixels in a corresponding segment of the scanning line. This reduces the number of delay stages in each transfer means, whereby degradation in analog signal caused by transfer can be suppressed.

Preferably, the D-A converting section includes D-A converters corresponding to the number of transfer means, and a switching means for switching connection between the D-A converters and the transfer means on a scanning-line-by-scanning-line basis. In this structure, the connection between the D-A converters and the transfer means is switched by the switching means every time a scanning line is selected. Therefore, even if there is an offset voltage between the outputs of the D-A converters, no fixed pattern noise will appear on the LCD, whereby degradation in image quality can be prevented.

Preferably, in the liquid crystal driver device of the present invention, the signal transfer section includes first and second signal transfer means, the D-A converting section includes first and second D-A converters respectively corresponding to the first and second transfer means, and the drive control section includes first and second drive circuits respectively corresponding to the first and second transfer means. In a layout of the liquid crystal driver device, the first transfer means, the first D-A converter and the first drive circuit are preferably arranged line-symmetrically with the second transfer means, the second D-A converter and the second drive circuit.

According to another aspect of the present invention, a unit forming a liquid crystal driver device for driving a LCD includes a signal end for receiving an analog signal, a drive control section for outputting a transfer clock signal and a drive control signal, a signal transfer section having a transfer means including series-connected delay stages, for sequentially transferring the analog signal applied to the signal end across the transfer means according to the transfer clock signal, and a signal output section for receiving the analog signal from each delay stage of the transfer means and outputting the received analog signal as a pixel signal of the LCD in response to the drive control signal.

### BRIEF DESCRIPTION OF THE DRAWINGS

FIG. 1 shows the overall structure of a liquid crystal display (LCD) system having a liquid crystal driver device;

FIG. 2 is a block diagram showing the structure of a liquid crystal driver device according to a first embodiment of the present invention;

FIG. 3 is a cross-sectional view showing the structure of a CCD (Charge Coupled Device) delay line;

FIG. 4 is a timing chart illustrating operation of a drive circuit in the first embodiment of the present invention;

FIG. 5 is a block diagram showing the structure of a liquid crystal driver device according to a second embodiment of the present invention;

FIG. 6 is a block diagram showing the structure of a liquid crystal driver device according to a third embodiment of the present invention;

FIG. 7 is a block diagram showing the structure of a liquid crystal driver device according to a fourth embodiment of the present invention;

FIGS. 8A, 8B and 8C illustrate technical significance of the fourth embodiment of the present invention;

FIG. 9 shows the overall structure of a LCD system having a liquid crystal driver unit according to the present invention;

FIG. 10 shows the internal structure of the liquid crystal driver unit in FIG. 9;

FIG. 11 shows the structure of a conventional liquid crystal driver device; and

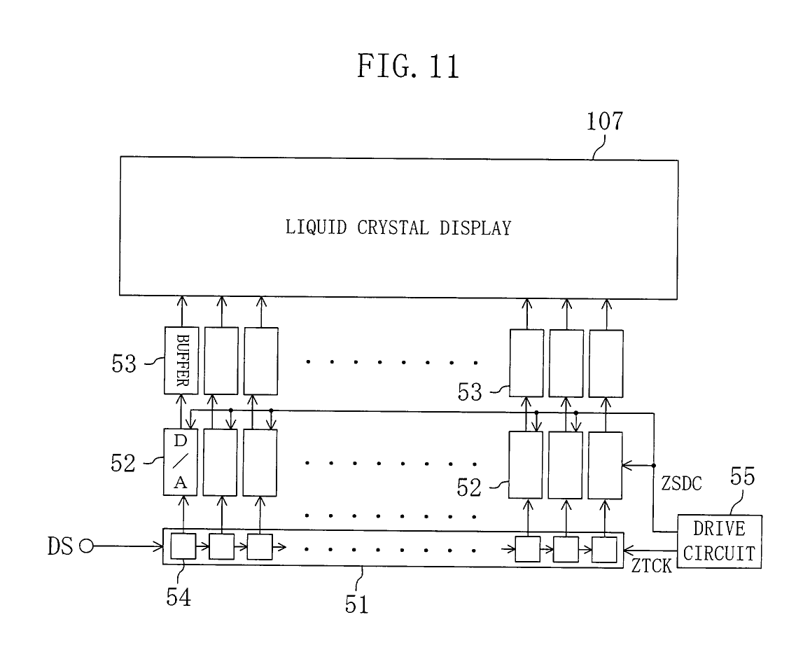

FIG. 12 is a timing chart illustrating operation of the liquid crystal driver device in FIG. 11.

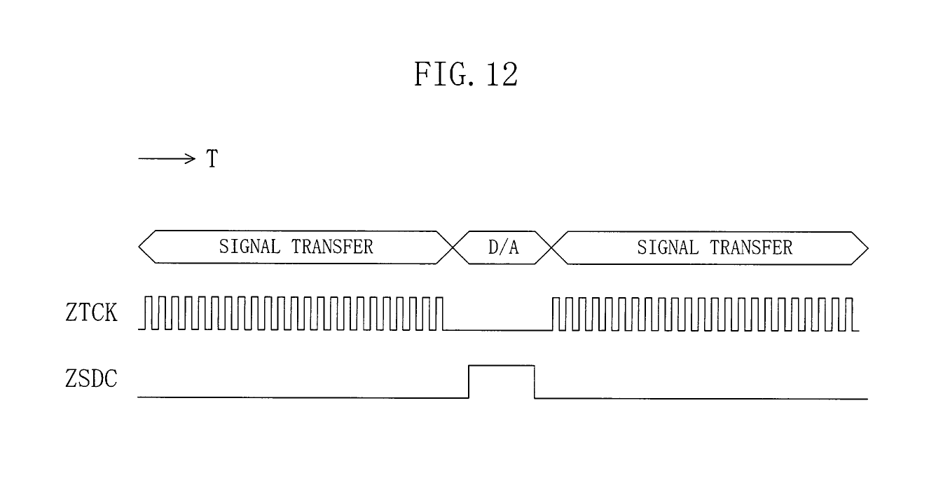

### DESCRIPTION OF THE PREFERRED EMBODIMENTS

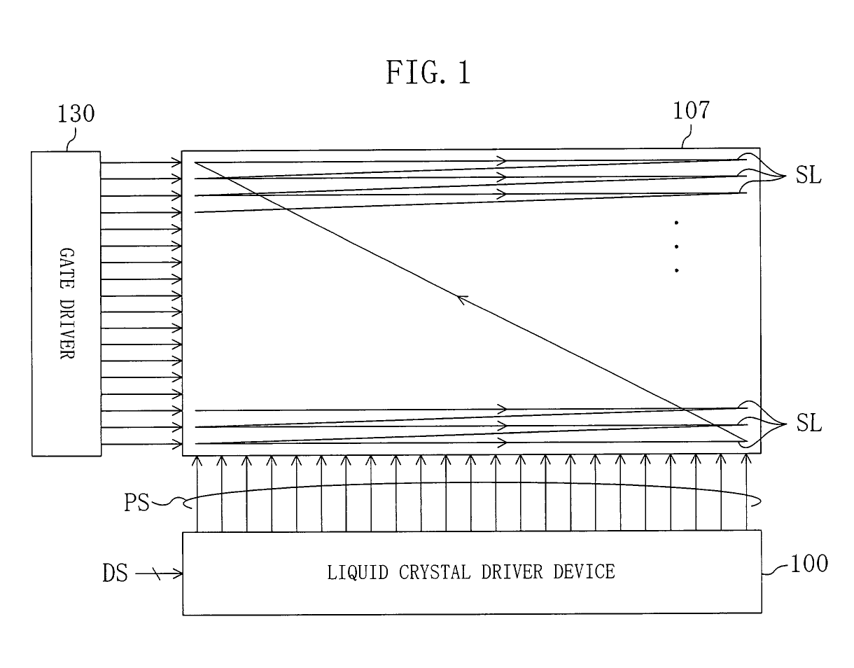

FIG. 1 shows the overall structure of a liquid crystal display (LCD) system having a liquid crystal driver device. Referring to FIG. 1, a liquid crystal display (LCD) 107 has a plurality of pixels arranged in a matrix, and a liquid crystal driver device 100 drives the LCD 107 according to a digital signal DS corresponding to the pixels. More specifically, a gate driver 130 sequentially selects a scanning line SL, and the liquid crystal driver device 100 outputs an analog pixel signal PS to each pixel on the selected scanning line SL within a horizontal period (i.e., a period during which this scanning line SL is ON). Each pixel of the LCD 107 provides gray scale display according to the received pixel signal PS.

(First Embodiment)

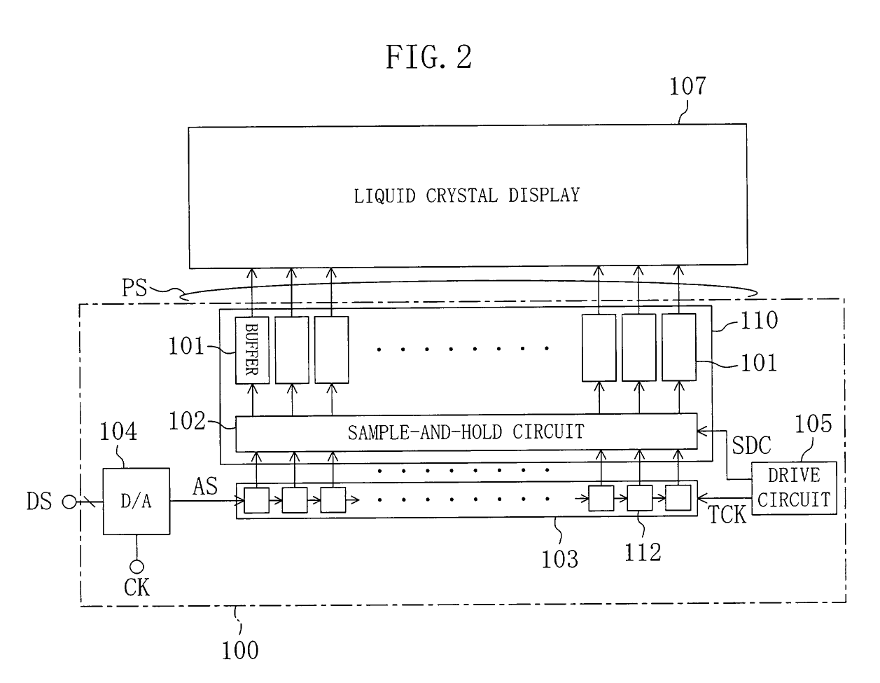

FIG. 2 is a block diagram showing the internal structure of a liquid crystal driver device according to the first embodiment of the present invention. As shown in FIG. 2, the liquid crystal driver device 100 includes a digital-to-analog (D-A) converter 104 for converting an input digital signal DS into an analog signal AS, a CCD (Charge Coupled Device) delay line 103 serving as a transfer means for sequentially transferring the analog signal AS, a signal output section 110 for outputting the analog signal AS received from the CCD delay line 103 as a pixel signal PS, and a drive circuit 105 for outputting a transfer clock signal TCK for controlling signal transfer operation of the CCD delay line 103 and a drive control signal SDC for controlling operation of the signal output section 110. The D-A converter 104 forms a D-A converting section, the CCD delay line 103 forms a signal transfer section, and the drive circuit 105 forms a drive control section.

In synchronization with a clock signal CK, the D-A converter 104 converts a digital signal DS into an analog signal AS for output to an input end of the CCD delay line 103. The D-A converter 104 outputs an analog signal AS corresponding to a single scanning line within each horizontal period.

The CCD delay line 103 has delay stages 112 connected in series with each other. The number of delay stages 112 corresponds to the number of pixels per scanning line. Each delay stage 112 has an output end. The CCD delay line 103 sequentially transfers a received analog signal AS corresponding to a single scanning line to the delay stages 112 according to a transfer clock signal TCK.

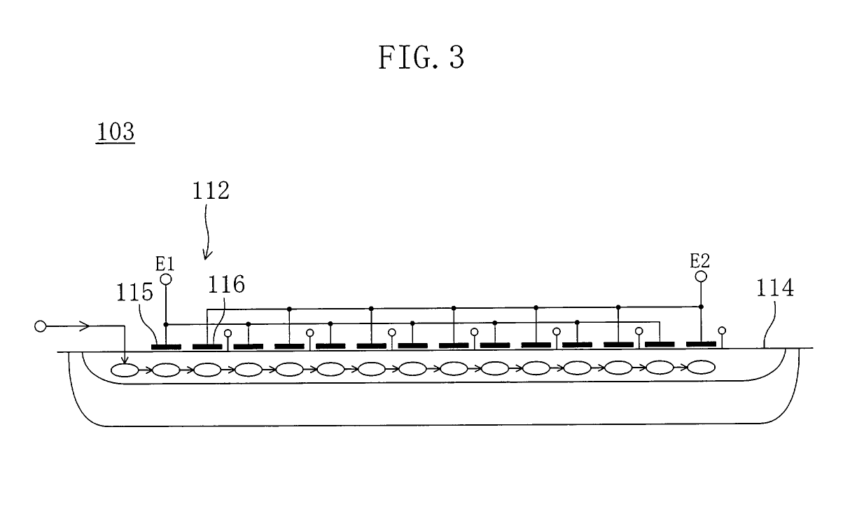

FIG. 3 is a cross-sectional view showing the structure of the CCD delay line 103. As shown in FIG. 3, each delay stage 112 has two electrodes 115, 116 formed on a semiconductor substrate 114 with an insulating film (not shown) interposed therebetween. The electrodes 115, 116 are arranged in line. Pulse voltages E1, E2 having a prescribed frequency are applied to each delay stage 112. The pulse voltages E1, E2 are in synchronization with the transfer clock signal TCK output from the drive circuit 105. The pulse voltage E1 is applied to the first electrode 115 and the pulse voltage E2 is applied to the second electrode 116.

When the pulse voltages E1, E2 are applied to the electrodes 115, 116, each delay stage 112 forms a potential well within the semiconductor substrate 114 under the electrodes 115, 116. Each delay stage 112 thus accumulates signal charges corresponding to an analog signal AS for driving a single pixel in the potential well. With the movement of the potential well, the accumulated signal charges are transferred to an adjacent delay stage 112.

The signal output section 110 includes a sample-and-hold circuit 102 for receiving an analog signal from the CCD delay line 103, and output buffers 101 for supplying an output signal of the sample-and-hold circuit 102 to the LCD 107 as a pixel signal PS. The number of output buffers 101 corresponds to the number of pixels per scanning line.

For example, the sample-and-hold circuit 102 is formed by a latch circuit. In response to a drive control signal SDC, the sample-and-hold circuit 102 fetches an analog signal transferred to each delay stage 112 of the CCD delay line 103. The sample-and-hold circuit 102 separately holds the fetched analog signals and outputs them to the respective output buffers 101. Each output buffer 101 outputs the analog signal received from the sample-and-hold circuit 102 to the LCD 107 as a pixel signal PS.

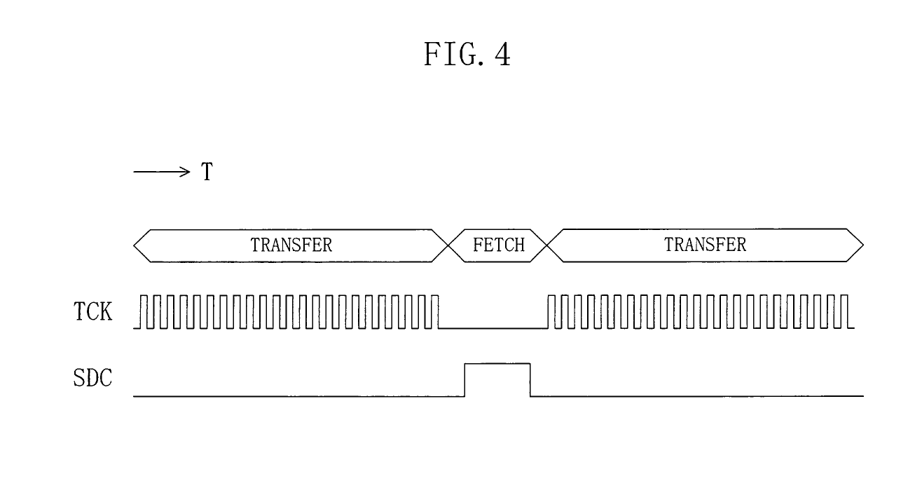

FIG. 4 is a timing chart illustrating operation of the drive circuit 105. As shown in FIG. 4, the drive circuit 105 outputs a transfer clock signal TCK so that the analog signal AS is sequentially transferred across the CCD delay line 103. Once the analog signal AS corresponding to a single scanning line is applied, the drive circuit 105 then outputs a drive control signal SDC to the sample-and-hold circuit 102.

Hereinafter, operation of the liquid crystal driver device 100 according to the present embodiment will be described.

A digital signal DS applied to the liquid crystal driver device 100 is applied to the D-A converter 104. In synchronization with a clock signal CK, the D-A converter 104 converts the digital signal DS into an analog signal AS for output to the CCD delay line 103. The analog signal AS corresponding to each pixel of the LCD 107 is sequentially applied from the D-A converter 104 to the CCD delay line 103. The analog signal AS corresponding to a single scanning line is applied within a horizontal period (i.e., a period during which the scanning line SL selected by the gate driver 130 is ON).

The analog signal AS applied to the CCD delay line 103 is first accumulated in the potential well of the delay stage 112 adjacent to the input end. The potential well is moved to an adjacent delay stage 112 when the applied voltages E1, E2 of the electrodes 115, 116 change in synchronization with a transfer clock signal TCK from the drive circuit 105. With the movement of the potential well, the analog signal AS is also transferred to the adjacent delay stage 112. In this way, the analog signal AS is sequentially transferred to each delay stage 112 in response to change in applied voltages E1, E2.

Once an analog signal AS corresponding to a single scanning line is applied to the CCD delay line 103, the drive circuit 105 then outputs a drive control signal SDC to the sample-and-hold circuit 102. In response to the drive control signal SDC, the sample-and-hold circuit 102 fetches the analog signal from each delay stage 112 of the CCD delay line 103. The sample-and-hold circuit 102 separately holds the analog signal thus fetched from each delay stage 112 and outputs it to the LCD 107 through each output buffer 101 as a pixel signal PS. The pixel signal PS is applied to each pixel on the scanning line SL of the LCD 107 selected by the gate driver 130, and each pixel provides gray scale display according to the received pixel signal PS.

The liquid crystal driver device 100 outputs a pixel signal PS every time the gate driver 130 selects a scanning line SL. As a result, all pixels of the LCD 107 can provide gray scale display according to the pixel signal PS.

According to the present embodiment, the D-A converter 104 first converts an input digital signal DS into an analog signal AS, which is then transferred across the CCD delay line 103. Therefore, unlike the conventional example, a multiplicity of D-A converters need no longer be provided corresponding to the number of pixels per scanning line. This enables implementation of a compact liquid crystal driver device 100 having a significantly simplified structure, and also enables reduction in costs of the components. Moreover, the use of the CCD delay line 103 as a means for transferring the analog signal AS enables reliable transfer of the analog signal AS.

Even when the bit width of the D-A converter is increased, the overall circuit area will not be significantly increased. Therefore, the D-A converter having a large bit width can be easily mounted with little limitation on the area as a liquid crystal driver device. As a result, the capability of the liquid crystal driver device 100 can be improved.

Note that, although high-speed operation is required for the D-A converter 104, the processing speed of about 100 MHz would be enough to drive the LCD 107. For example, a 10-bit D-A converter with a frequency of about 200 MHz may be used.

When the liquid crystal driver device 100 is fabricated on a silicon substrate or the like, the D-A converter 104 is preferably provided on the symmetry axis of the layout of the liquid crystal driver device 100 in view of the influences of electric characteristics of the D-A converter 104 on the pixel signal PS.

(Second Embodiment)

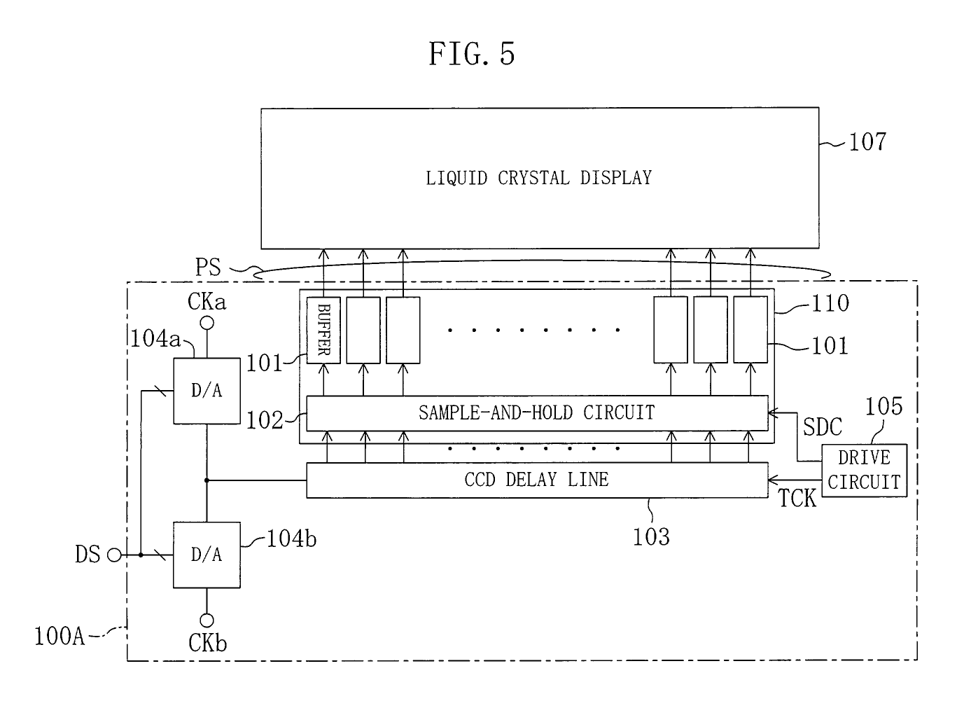

FIG. 5 is a block diagram showing the structure of a liquid crystal driver device according to the second embodiment of the present invention. As shown in FIG. 5, the liquid crystal driver device 100A of the second embodiment has two D-A converters 104a, 104b as a D-A converting section.

The first and second D-A converters 104a, 104b are provided in parallel between an input end receiving a digital signal DS and an input end of the CCD delay line 103, and operate in parallel. More specifically, the first D-A converter 104a operates in synchronization with a first clock signal CKa, and the second D-A converter 104b operates in synchronization with a second clock signal CKb. The first and second clock signals CKa, CKb have the same period, but have a phase difference corresponding to half the period.

Each of the first and second clock signals CKa, CKb has half the frequency of the clock signal CK in the first embodiment. In other words, the D-A converters 104a, 104b operate at half the clock frequency of the D-A converter 104 in the first embodiment.

The first and second D-A converters 104a, 104b fetch a digital signal DS in response to a pulse edge of the respective clock signals CKa, CKb. Since the clock signals CKa, CKb have a phase difference corresponding to half the period; the D-A converters 104a, 104b fetch the digital signal DS at different timings. In other words, the digital signal DS is alternately applied to the first D-A converter 104a and the second D-A converter 104b.

The D-A converters 104a, 104b each converts the received digital signal DS into an analog signal AS for output. More specifically, the D-A converters 104a, 104b alternately output an analog signal AS to the CCD delay line 103. The processing is subsequently conducted in the same manner as that of the first embodiment.

The frequency at which the analog signal AS is applied to the CCD delay line 103 is the same as that of the first embodiment. In the second embodiment, the D-A converters 104a, 104b operate at half the clock frequency of the D-A converter 104 in the first embodiment, and convert digital signals DS corresponding to different pixels into analog signals in parallel. This enables implementation of the operation speed as high as that of the first embodiment.

According to the present embodiment, the D-A converting section is formed by two D-A converters 104a, 104b operating in parallel. This enables the use of a D-A converter having a lower clock frequency. As a result, EMI noise as well as costs of the components can be reduced.

Note that the number of D-A converters of the D-A converting section is not limited to two, and three or more D-A converters may be provided in parallel. In this case, the operating clock frequency of the D-A converter can further be reduced.

(Third Embodiment)

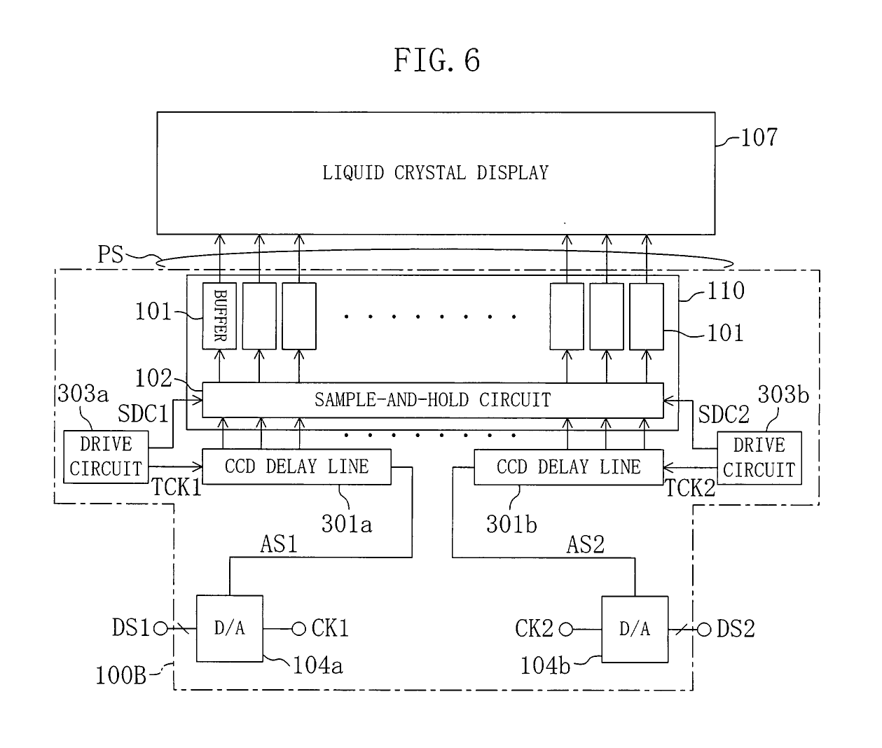

FIG. 6 is a block diagram showing the structure of a liquid crystal driver device according to the third embodiment of the present invention. As shown in FIG. 6, the liquid crystal driver device 100B of the third embodiment includes two D-A converters 104a, 104b, two CCD delay lines 301a, 301b, and two drive circuits 303a, 303b. The first and second D-A converters 104a, 104b forms a D-A converting section. The first and second CCD delay lines 301a, 301b as first and second transfer means form a signal transfer section. The first and second drive circuits 303a, 303b form a drive control section.

The first D-A converter 104a receives a first digital signal DS1 for driving the pixels in the left half of the LCD 107. The output of the first D-A converter 104a is applied to the first CCD delay line 301a. On the other hand, the second D-A converter 104b receives a second digital signal DS2 for driving the pixels in the right half of the LCD 107. The output of the second D-A converter 104b is applied to the second CCD delay line 301b.

The first D-A converter 104a operates in synchronization with a first clock signal CK1, and the second D-A converter 104b operates in synchronization with a second clock signal CK2. Each of the first and second clock signals CK1, CK2 has half the frequency of the clock signal CK in the first embodiment. In other words, the D-A converters 104a, 104b operate at half the clock frequency of the D-A converter 104 in the first embodiment.

The number of delay stages in each of the first and second CCD delay lines 301a, 301b is half the number of delay stages 112 in the CCD delay line 103 of the first embodiment. The first and second CCD delay lines 301a, 301b operate in parallel. The first CCD delay line 301a corresponds to one half of each scanning line SL of the LCD 107, and the second CCD delay line 301b corresponding to the other half of each scanning line SL of the LCD 107.

The first CCD delay line 301a receives from the first D-A converter 104a an analog signal AS1 for driving the pixels in the left half of the LCD 107, and sequentially transfers the analog signal AS1 in synchronization with a first transfer cock signal TCK1 output from the first drive circuit 303a. On the other hand, the second CCD delay line 301b receives from the second D-A converter 104b an analog signal AS2 for driving the pixels in the right half of the LCD 107, and sequentially transfers the analog signal AS2 in synchronization with a second transfer cock signal TCK2 output from the second drive circuit 303b.

Each of the first and second transfer clock signals TCK1, TCK2 is a clock signal having half the frequency of the transfer clock signal TCK in the first embodiment. Therefore, the first and second CCD delay lines 301a, 301b transfer the analog signals AS1, AS2 at half the transfer rate of the CCD delay line 103 in the first embodiment.

The first drive circuit 303a outputs a first transfer clock signal TCK1 to the first CCD delay line 301a, and outputs a first drive control signal SDC1 to the sample-and-hold circuit 102 after an analog signal AS1 corresponding to a single scanning line is applied to the first CCD delay line 301a. Similarly, the second drive circuit 303b outputs a second transfer clock signal TCK2 to the second CCD delay line 301b, and outputs a second drive control signal SDC2 to the sample-and-hold circuit 102 after an analog signal AS2 corresponding to a single scanning line is applied to the second CCD delay line 301b.

The sample-and-hold circuit 102 fetches the analog signal AS1 transferred to each delay stage in the first CCD delay line 301a in response to the first drive control signal SDC1, and fetches the analog signal AS2 transferred to each delay stage in the second CCD delay line 301b in response to the second drive control signal SDC2. The sample-and -hold circuit 102 temporarily holds the fetched analog signals AS1, AS2 for output to the output buffers 101.

Hereinafter, operation of the liquid crystal driver device 100B of the present embodiment will be described.

When a first digital signal DS1 for driving the pixels in the left half of the LCD 107 is applied to the first D-A converter 104a, the first D-A converter 104a converts the first digital signal DS1 into an analog signal AS1 and outputs the analog signal AS1 to the first CCD delay line 301a in synchronization with a first clock signal CK1. The analog signal AS1 applied to the first CCD delay line 301a is sequentially transferred across the delay stages according to a first transfer clock signal TCK1. Once the analog signal AS1 corresponding to a single scanning line is applied to the first CCD delay line 301a, the sample-and-hold circuit 102 then fetches the analog signal AS1 from the first CCD delay line 301a in response to a first drive control signal SDC1.

On the other hand, when a second digital signal DS2 for driving the pixels in the right half of the LCD 107 is applied to the second D-A converter 104b, the second D-A converter 104b converts the second digital signal DS2 into an analog signal AS2 and outputs the analog signal AS2 to the second CCD delay line 301b in synchronization with a second clock signal CK2. The analog signal AS2 applied to the second CCD delay line 301b is sequentially transferred across the delay stages according to a second transfer clock signal TCK2. Once the analog signal AS2 corresponding to a single scanning line is applied to the second CCD delay line 301b, the sample-and-hold circuit 102 then fetches the analog signal AS2 from the second CCD delay line 301b in response to a second drive control signal SDC2.

The analog signals AS1, AS2 fetched by the sample-and-hold circuit 102 are applied to each pixel of the LCD 107 through the output buffers 101.

According to the present embodiment, a signal transfer section is formed by two CCD delay lines 301a, 301b. This reduces the number of delay stages in each CCD delay line 301a, 301b, whereby degradation in signal caused by transfer can be suppressed. Like the second embodiment, a D-A converting section is formed by two D-A converters 104a, 104b operating in parallel. This enables the use of a D-A converters having a lower clock frequency. As a result, EMI noise as well as costs of the components can be reduced.

Note that the number of CCD delay lines is not limited to two, and three or more CCD delay lines may be used. In this case, each of the number of D-A converters and the number of drive circuits is preferably the same as that of CCD delay lines.

Note that, in the layout of the liquid crystal driver device 100B on a silicon substrate or the like, the first CCD delay line 301a, the first D-A converter 104a and the first drive circuit 303a are preferably arranged line-symmetrically with the second CCD delay line 301b, the second D-A converter 104b and the second drive circuit 303b. This facilitates arrangement of the wirings for connecting the components.

(Fourth Embodiment)

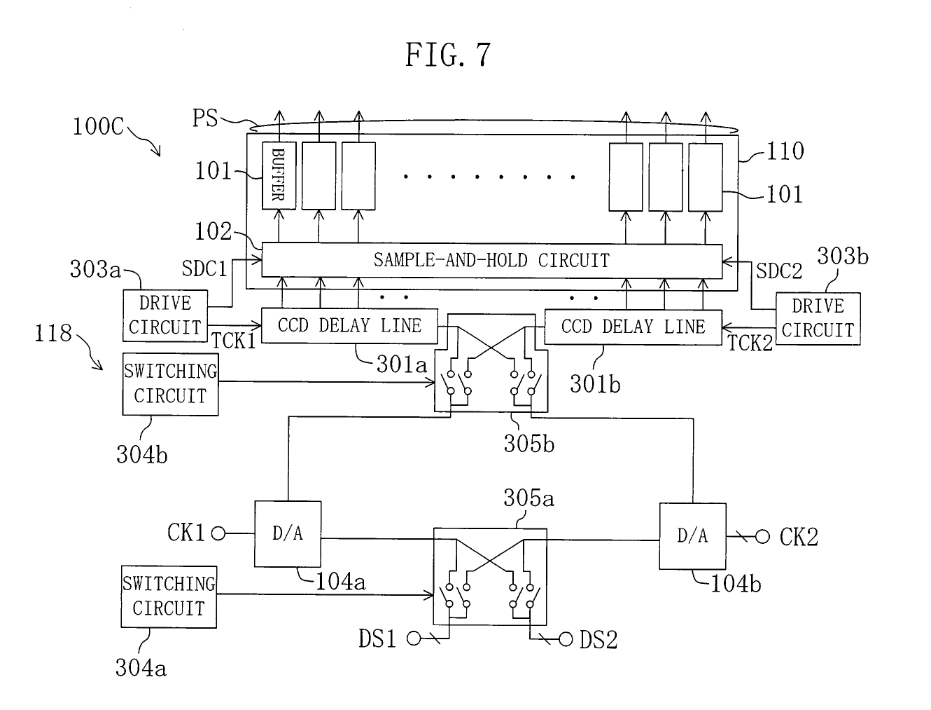

FIG. 7 is a block diagram showing the structure of a liquid crystal driver device according to the fourth embodiment of the present invention. As shown in FIG. 7, the liquid crystal driver device 100C of the present embodiment includes a switching means 118 for switching the connection between first and second D-A converters 104a, 104b and first and second CCD delay lines 301a, 301b serving as transfer means on a scanning -line-by-scanning-line basis. The first and second D-A converters 104a, 104b and the switching means 118 form a D-A converting section.

The switching means 118 includes first and second switching circuits 304a, 304b and first and second switches 305a, 305b. The first switch 305a has two input ends and two output ends. The first switch 305a receives a first digital signal DS1 at one input end and receives a second digital signal DS2 at the other input end. One output end of the first switch 305a is connected to the first D-A converter 104a, and the other output end is connected to the second D-A converter 104b. The second switch 305b has two input ends and two output ends. One input end of the second switch 305b is connected to the first D-A converter 104a, and the other input end is connected to the second D-A converter 104b. One output end of the second switch 305b is connected to the first CCD delay line 301a, and the other output end is connected to the second CCD delay line 301b.

The first switch 305a switches between a first state and a second state. In the first state, the first switch 305a allows the first digital signal DS1 to be applied to the first D-A converter 104a and also allows the second digital signal DS2 to be applied to the second D-A converter 104b. In the second state, the first switch 305a allows the first digital signal DS1 to be applied to the second D-A converter 104b and also allows the second digital signal DS2 to be applied to the first D-A converter 104a. The second switch 305b also switches between a first state and a second state. In the first state, the second switch 305b allows the output signal of the first D-A converter 104a to be applied to the first CCD delay line 301a and also allows the output signal of the second D-A converter 104b to be applied to the second CCD delay line 301b. In the second state, the second switch 305b allows the output signal of the first D-A converter 104a to be applied to the second CCD delay line 301b and also allows the output signal of the second D-A converter 104b to be applied to the first CCD delay line 301a.

The first switching circuit 304a selectively sets the first switch 305a to the first or second state. The second switching circuit 304b selectively sets the second switch 305b to the first or second state. The first and second switching circuits 304a, 304b operate in synchronization with the gate driver 130. In other words, the first and switching circuits 304a, 304b switch both the first and second switches 305a, 305b to the first state or the second state every time the gate driver 130 selects a scanning line SL.

When the first and second switches 305a, 305b are both set to the first state, the first D-A converter 104a converts the first digital signal DS1 into an analog signal for output to the first CCD delay line 301a, whereas the second D-A converter 104b converts the second digital signal DS2 into an analog signal for output to the second CCD delay line 301b. On the other hand, when the first and second switches 305a, 305b are both set to the second state, the second D-A converter 104b converts the first digital signal DS1 into an analog signal for output to the first CCD delay line 301a, whereas the first D-A converter 104a converts the second digital signal DS2 into an analog signal for output to the second CCD delay line 301b.

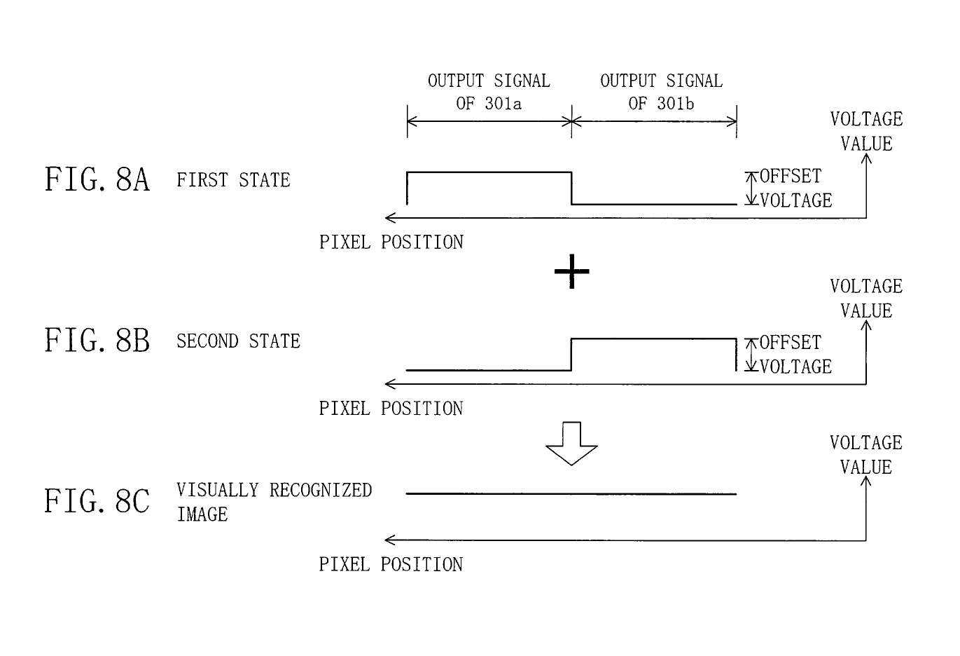

Hereinafter, technical significance of the present embodiment will be described with reference to FIGS. 8A to 8C.

When the outputs of the first and second D-A converters 104a, 104b have a potential difference, an offset voltage is produced between the pixel signals PS for the left half and right half of the LCD 107. This results in the noise which is visually recognized as a fixed pattern on the screen, thereby degrading the image quality. In the present embodiment, such a fixed pattern noise is eliminated by switching the connection between the D-A converters 104a, 104b and the CCD delay lines 301a, 301b every time a scanning line SL is selected.

It is now assumed that the first D-A converter 104a has a higher output voltage than that of the second D-A converter 104b. As shown in FIG. 8A, provided that the first and second switches 305a, 305b are both set to the first state in response to selection of a scanning line SL by the gate driver 130, the output signal of the first CCD delay line 301a has a voltage higher than that of the output signal of the second CCD delay line 301b by the offset voltage. Accordingly, the voltage applied to the pixels in the left half of the LCD 107 is higher than that applied to the pixels in the right half thereof

When the gate driver 130 selects the following scanning line SL, the first and second switches 305a, 305b are both set to the second state. As a result, the relation between the voltages of the output signals of the first and second CCD delay lines 301a, 301b is reversed as shown in FIG. 8B. More specifically, the output signal of the second CCD delay line 301b has a voltage higher than that of the output signal of the first CCD delay line 301a by the offset voltage. Accordingly, the voltage applied to the pixels in the right half of the LCD 107 is lower than that applied to the pixels in the right half thereof.

In this way, the first and second switches 305a, 305b are switched every time a scanning line SL is selected. As a result, as shown in FIG. 8C, the voltages applied to the pixels in the left half and right half of the LCD 107 are averaged, whereby the noise visually recognized as a fixed pattern is eliminated. In other words, the viewer of the LCD 107 recognizes the image as if there were no offset voltage.

As has been described above, according to the present embodiment, the D-A converters 104a, 104b are switched every time a scanning line is selected. Therefore, even if there is an offset voltage between the outputs of the D-A converters 104a, 104b, no fixed pattern noise will appear on the LCD 107, whereby degradation in image quality can be prevented.

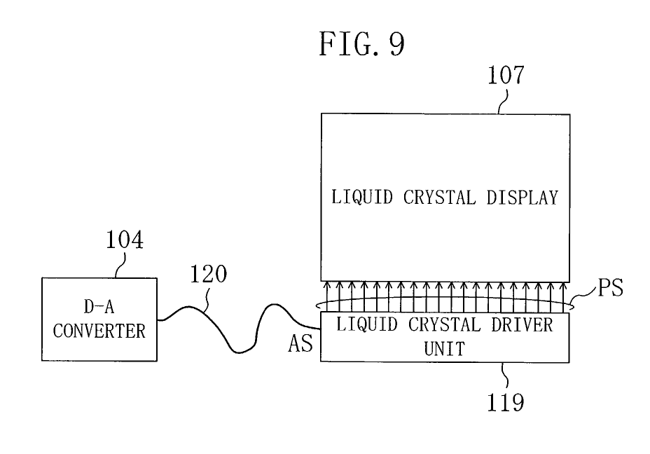

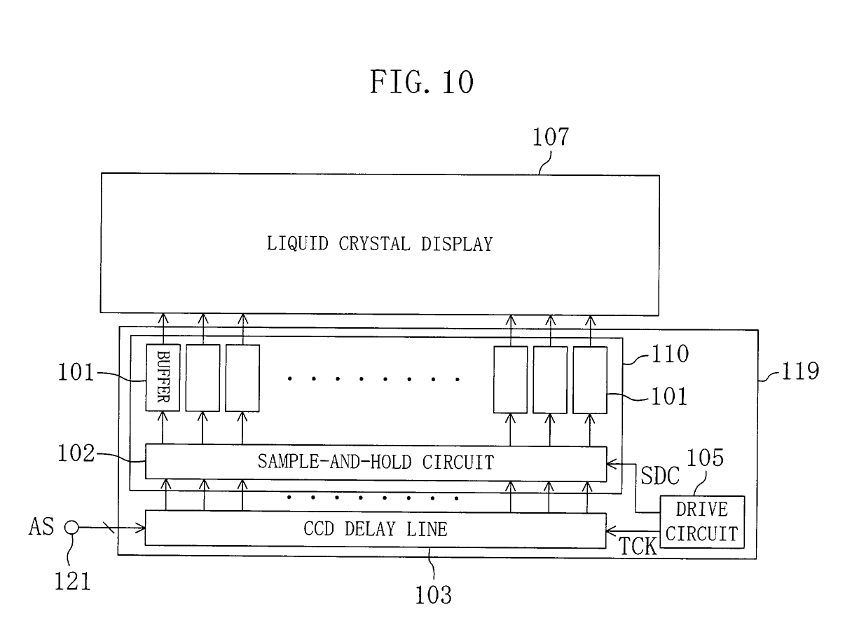

Note that, as shown in FIG. 9, the liquid crystal driver device of the present invention may be formed by a D-A converter 104 and a liquid crystal driver unit 119 having the other components. For example, as shown in FIG. 10, the liquid crystal driver unit 119 includes a CCD delay line 103, a drive circuit 105 and a signal output section 110. The CCD delay line 103 receives at its input end 121 an analog signal AS output from the D-A converter 104 through a transmission line 120. In this case, the liquid crystal driver unit 119 and the D-A converter 104 form the liquid crystal driver device 100 of the first embodiment. The use of the liquid crystal drive unit 119 improves design flexibility.

Note that, in each of the above embodiments, the CCD delay line forms a transfer means. However, the CCD delay line may be replaced with another component as long as it is capable of sequentially transmitting an analog signal.

As has been described above, according to the present invention, a digital signal corresponding to each pixel of the LCD is first converted into an analog signal by a D-A converting section, and the analog signal is then transferred by a transfer means. This structure eliminates the need to provide a multiplicity of D-A converters corresponding to the number of pixels per scanning line. As a result, the structure of the liquid crystal driver device can be significantly simplified.

What is claimed is:

1. A liquid crystal driver device for driving a liquid crystal display (LCD) according to a digital signal corresponding to each pixel of the LCD, comprising:
a digital-to-analog (D-A) converting section for converting the digital signal into an analog signal;
a drive control section for outputting a transfer clock signal and a drive control signal;
a signal transfer section having a transfer means including series-connected delay stages, for sequentially transferring the analog signal output from the D-A converting section across the transfer means according to the transfer clock signal; and
a signal output section for receiving the analog signal from each delay stage of the transfer means and outputting the received analog signal as a pixel signal of the LCD in response to the drive control signal.

2. The liquid crystal driver device according to claim 1, wherein the transfer means is formed by a CCD (Charge Coupled Device) delay line.

3. The liquid crystal driver device according to claim 1, wherein the D-A converting section is provided on a symmetry axis of a layout of the liquid crystal driver device.

4. The liquid crystal driver device according to claim 1, wherein
the D-A converting section includes a plurality of D-A converters, and
the D-A converters convert digital signals corresponding to different pixels into analog signals in parallel.

5. The liquid crystal driver device according to claim 1, wherein
the signal transfer section includes a plurality of transfer means, and
the plurality of transfer means respectively correspond to a plurality of segments of a scanning line of the LCD, and the number of delay stages included in each transfer means is at least the same as the number of pixels in a corresponding segment of the scanning line.

6. The liquid crystal driver device according to claim 5, wherein the D-A converting section includes
D-A converters corresponding to the transfer means in number, and
a switching means for switching connection between the D-A converters and the transfer means on a scanning-line-by-scanning-line basis.

7. The liquid crystal driver device according to claim 1, wherein
the signal transfer section includes first and second signal transfer means,
the D-A converting section includes first and second D-A converters respectively corresponding to the first and second transfer means,
the drive control section includes first and second drive circuits respectively corresponding to the first and second transfer means, and
in a layout of the liquid crystal driver device, the first transfer means, the first D-A converter and the first drive circuit are arranged line-symmetrically with the second transfer means, the second D-A converter and the second drive circuit.

8. A unit forming a liquid crystal driver device for driving a liquid crystal display (LCD), comprising:
a signal end for receiving an analog signal;
a drive control section for outputting a transfer clock signal and a drive control signal;
a signal transfer section having a transfer means including series-connected delay stages, for sequentially transferring the analog signal applied to the signal end across the transfer means according to the transfer clock signal; and
a signal output section for receiving the analog signal from each delay stage of the transfer means and outputting the received analog signal as a pixel signal of the LCD in response to the drive control signal.
